(19) United States
(12) Patent Application Publication
(10) Pub. No.: US 2009/0061695 A1
(43) Pub. Date: Mar. 5, 2009

(54) Cable assembly with improved insulative organizer

(75) Inventors: David Tso-Chin Ko, Fullerton, CA (US); Hai-Wei Wang, Kunshan (CN); Xiao-Dong Wang, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/229,633

(22) Filed: Aug. 25, 2008

(30) Foreign Application Priority Data
Aug. 28, 2007 (CN) 200720045593.9

(51) Int. Cl. H01R 13/10

(52) U.S. Cl. 439/682

(57) ABSTRACT

A cable assembly in accordance with the present invention comprises an insulative housing defining a body portion and a supporting member extending rearwardly from the body portion, and the supporting member having a plurality of upper and lower slots thereof; a plurality of terminals received in the insulative housing and having a portion disposed in the upper and lower slots respectively; an insulative organizer assembled to the rear end of insulative housing and attached to the supporting member, having a plurality of first and second channels spaced by each other and respectively formed on the front and rear portion thereof; and a plurality of conductive wires positioned in the first and second channels of the insulative organizer and electrically terminated to the corresponding terminals disposed in the upper and lower slots.

### FIELD OF THE INVENTION

The present invention relates to a cable assembly, and more particularly to a kind of cable assembly with an improved insulative organizer for positioning the cable easily and making the cable electrically terminated with the terminals conveniently.

### DESCRIPTION OF PRIOR ART

Generally the spacer for retaining the cable disposed in the cable assembly is usually used for tidying up the cables and the conductors therein, however, the cable supported by the spacer can not be well positioned, in addition, when the conductors disposed in the cable are welding with the terminals, the connection between the cables and the contacts are easily loosed by the force from outside during the process of the weld, so the cables and the contacts are not easily to be welded and the effect of the weld between the cables and the contacts is also not very well.

U.S. Pat. No. 6,039,611 issued to Yang on Mar. 21, 2000 discloses a kind of cable assembly with a spacer for retaining the cable, please referring to FIGS. 3 to 6 in the above mentioned patent. As shown, the cable assembly comprises a plastic body 1, a plurality of insertion terminals 11, an insertion body 2, two covers 3, a steel case 4, and two interconnecting cables 7. The insertion body 2 is assembled to the rear end of the plastic body 1, rear ends of the insertion terminals 11 are located in their respective corresponding terminal slots 21 of the insertion body 2, the interconnecting cable 7 assembled to the insertion body 2 each defines a plurality of conductors 71 spaced by the clamping pieces 73. Front ends of the conductors 71 extended from the clamping pieces 73 are stripped to become equally spaced bare conductors 72, the connection area between the insertion terminals 11 and the bare conductors are disposed in the terminal slots 21 of the insertion body 2. Further, two covers 3 are assembled to the plastic body 1.

Whereas, the structure of the cable assembly description in the above mentioned patent is relative complexity due to the much more elements in the cable assembly, thus, the process of assembling the cable assembly is not convenient and will be spent more time on it. As the above situation, the efficiency of assembling the cable assembly and the qualification rates of the cable assembly will at a lower level.

As discussed above, an improved cable assembly overcoming the shortages of existing technology is needed.

### SUMMARY OF THE INVENTION

Accordingly, an object of the present invention is to provide a cable assembly having an improved insulative organizer for conveniently and firmly positioning the cables.

A further object of the present invention is to provide a kind of cable assembly with high efficiency of the assembling and high qualification rates.

In order to achieve the above-mentioned objects, a cable assembly in accordance with the present invention comprises an insulative housing defining a body portion and a supporting member extending rearwardly from the body portion, and the supporting member having a plurality of upper and lower slots thereof; a plurality of terminals received in the insulative housing and having a portion disposed in the upper and lower slots respectively; an insulative organizer assembled to the rear end of insulative housing and attached to the supporting member, having a plurality of first and second channels spaced by each other and respectively formed on the front and rear portion thereof; and a plurality of conductive wires positioned in the first and second channels of the insulative organizer and electrically terminated to the corresponding terminals disposed in the upper and lower slots.

Other objects, features and advantages of the invention will be apparent from the following detailed description taken in connection with the accompanying drawings.

### BRIEF DESCRIPTION OF THE DRAWINGS

FIG. 1 is a perspective view of a cable assembly made in accordance with the present invention;

FIG. 2 is an exploded, perspective view of the cable assembly of FIG. 1;

FIG. 3 is an exploded, perspective view of the cable assembly in another point of view different from FIG. 2;

FIG. 4 is an exploded, perspective view of the conductive wires and insulative organizer of the cable assembly;

FIG. 5 is an exploded, perspective view of the conductive wires and insulative organizer of the cable assembly in another point of view different from FIG. 4;

FIG. 6 is a partial perspective view of the cable assembly made in accordance with the present invention;

FIG. 7 is another partial perspective view of the cable assembly made in accordance with the present invention;

FIG. 8 is a cross-section view of the cable assembly taken along line 8-8 of FIG. 1.

### DETAILED DESCRIPTION OF PREFERRED EMBODIMENTS

Reference will now be made to the drawing figures to describe the present invention in detail.

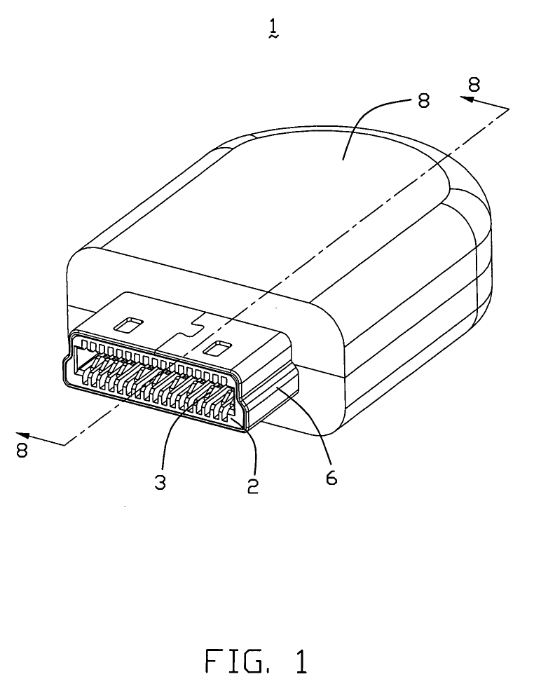

Referring to FIGS. 1 to 3, a cable assembly 1 with an improved insulative organizer 4 in accordance with the present invention adapter for mating with the complementary connector (not shown in FIGS.) includes an insulative housing 2, a plurality of terminals 3 received in the insulative housing 2, an insulative organizer 4 attached to rear end of the insulative housing 2, a plurality of conductive wires 5 positioned in the insulative organizer 4 and electrically terminated to the corresponding terminals 3 respectively, a first metal shell 6 assembled to the mating portion 22 of the insulative housing 2, a second metal shell 7 assembled to the body portion 21 and the first and second side walls 24, 25 of the insulative housing 2, and an insulative cover 8 assembled to the second metal shell 7.

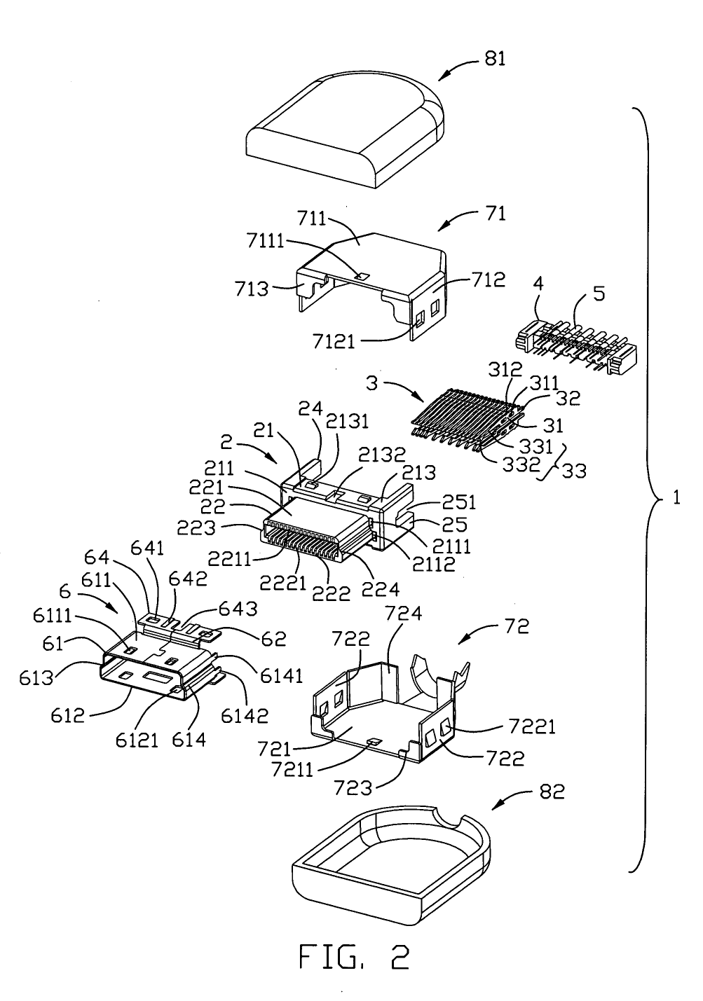

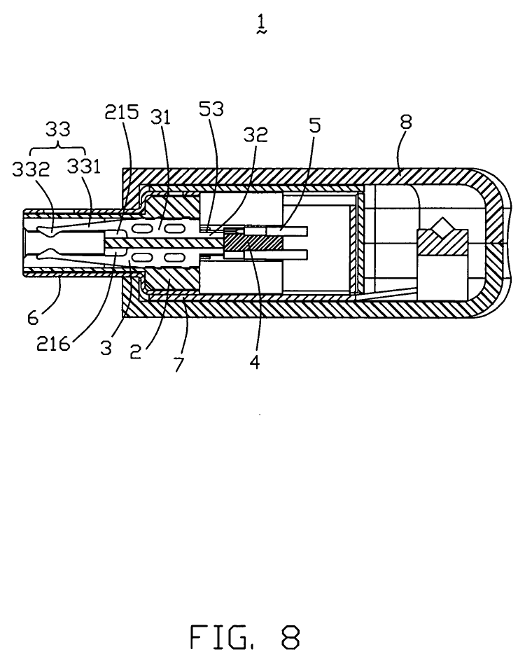

Referring to FIGS. 2 to 3 and 8, the insulative housing 2 includes a body portion 21, a mating portion 22, a supporting member 23, a first side wall 24 and a second side wall 25.

The body portion 21 of the insulative housing 2 defines a front surface 211 and an opposite rear surface 212, a top surface 213 and an opposite bottom surface 214. A plurality of upper passageways 215 and lower passageways 216 are formed in the body portion 21 and arranged in a transverse direction. A pair of holes 2111 and another pair of holes 2112 are respectively formed at two sides of the body potion 21 and recessed into the body portion 21 from its front surface 211. A pair of projections 2131 and another pair of projections 2141 are respectively formed on the top surface 213 and bottom surface 214 of the body portion 21, and a pair of recess portions 2132, 2142 are respectively formed on the top surface 213 and bottom surface 214 of the body portion 21 and disposed between the projections 2131, 2141.

The mating portion 22 of the insulative housing 2 can be mated with the complementary connector (not shown in FIGS.), the mating portion 22 extends forwardly from the front surface 211 of the body portion 21 along the mating direction. The mating portion 22 defines a top wall 221, a bottom wall 222 and a pair of first side and second side walls 223, 224 connecting with the top wall 221 and the bottom wall 222. A rectangular receiving space is enclosed by the top wall 221, bottom wall 222 and first side and second side walls 223, 224. A plurality of upper and lower channels 2211, 2221 are respectively formed on the inner surface of the top wall 221 and bottom wall 222 and communicated to the upper and lower passageways 215, 216 of the body portion 21.

The supporting member 23 of the insulative housing 2 extending rearwardly from the rear surface 212 of the body portion 21 defines a plurality of upper and lower slots 231, 232 respectively corresponding to the upper and lower passageways 215, 216 and upper and lower channels 2211, 2221.

The first and second side walls 24, 25 of the insulative housing 2 extending rearwardly from two opposite sides of the body portion 21 each has a U-shaped slot 241, 251 pass through the first and second side walls 24, 25 in a transverse direction. A pair of spaces are respectively formed between the first side wall 24 and the supporting member 23, the second side wall 25 and the supporting member 23 in a widthwise direction.

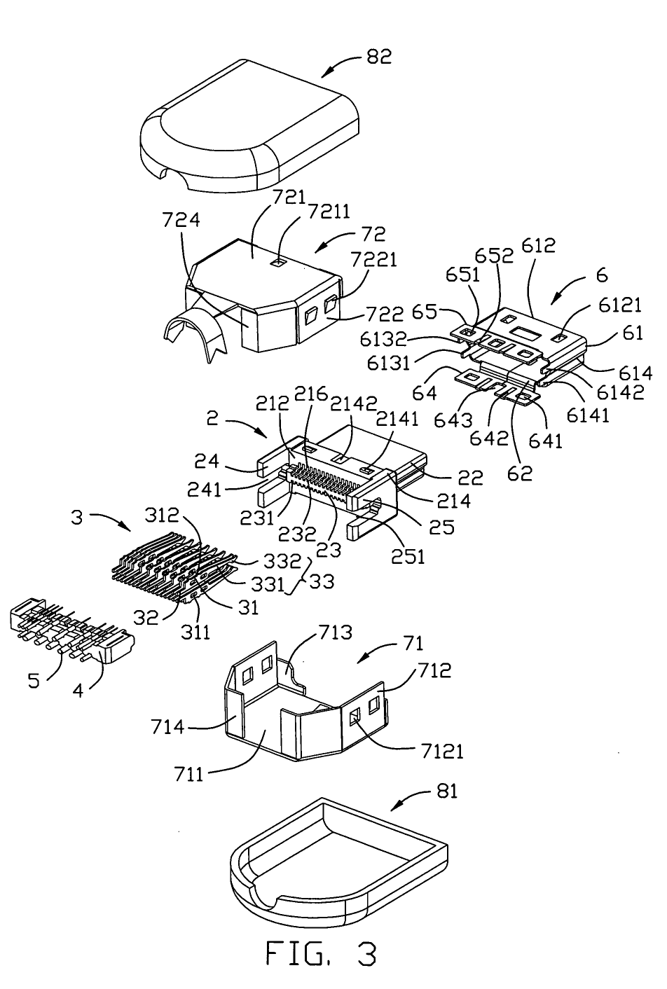

Referring to FIGS. 2 to 3, each of the terminals 3 includes a fixing portion 31 as a middle portion, a contact piece 33 as a front half portion extending forwardly from the fixing portion 31 and a connecting portion 32 as a rear half portion extending rearwardly from the fixing portion 31.

Each of the fixing portions 31 has two holes 35 arranged in a substantially one row along a mating direction at a substantially center portion thereof. The holes 35 are formed in opposing portions of adjacent terminals 3, so that it is possible to reduce opposing areas between the terminals 30 and capacitance to be generated there between. The fixing portion 31 further has a few of serrated protrusion 312 formed on its top or bottom surface for interfering with the insulative housing 2.

The contact pieces 33 includes a resilient connecting arm 331 extending forwardly from the fixing portion 31 and a contact portion 332 shape tapered extending upwardly and is provided at distal ends of the contact pieces 33. The contact piece 33 of each of the terminals 3 has elasticity to be freely movable up and down.

Referring to FIGS. 2 to 5, the insulative organizer 4 includes a base portion 41, a first side portion 42 and a second side portion 43. The first and second side portions 42, 43 extend laterally from opposite sides of the base portion 41 respectively.

The base portion 41 defines two slots 413 respectively formed on its top surface 411 and bottom surface 412 extending in a transverse direction. The base portion 41 further defines a plurality of first channels 414 formed on the front portion thereof and a plurality of second channels 415 formed on the rear portion thereof extending in a longitudinal direction, the first channels 414 and second channels 415 are spaced by the slots 413. A few of first channels 414 are corresponding to the second channels 415 in a one-to-one relationship, and a few of first channels 414 are corresponding to the second channels 415 in a two-to-one relationship, and the width of the first channels 414 is narrower than the width of the second channels 415. A few of first channels 415 are spaced by the slot wall 4141 which has a pair of chamfers 4142 respectively formed on the opposite sides thereof.

The first and second side portions 42, 43 have the same structure, each has a basic plate 421, 431 extending outwardly from opposite sides of the base portion 41 and a U-shaped projection 422, 432 extended outwardly from the basic plate 421, 431. In addition, each of the first and second side portions 42, 43 has a pair of ribs 4221, 4321 respectively formed on the opposite top and bottom surfaces thereof and extending in a longitudinal direction.

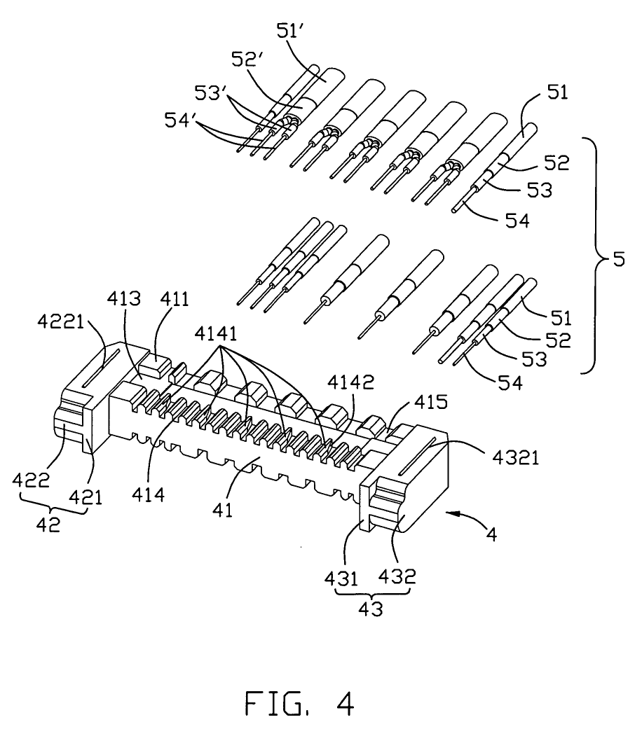

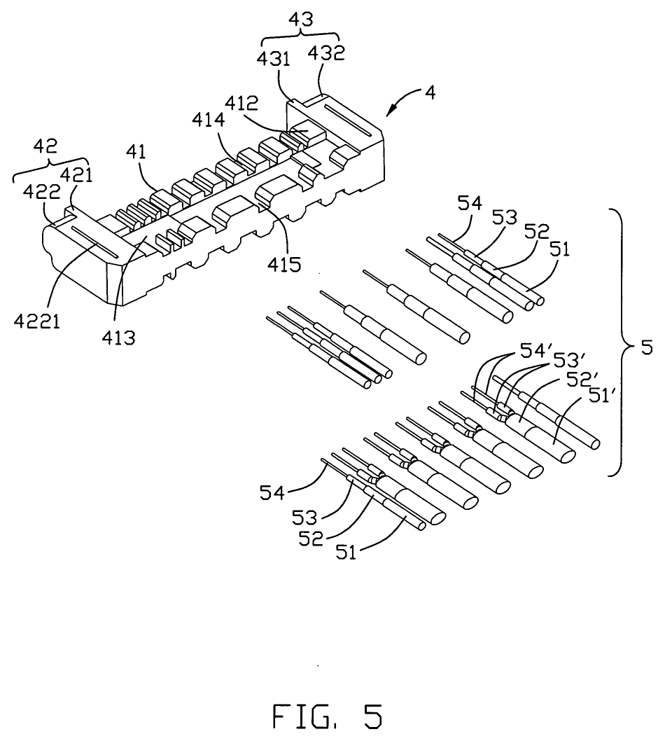

Referring to FIGS. 4 to 5, the conductive wire 5 is a micro-coaxial wire comprising a conductor 54, an inner insulative layer 53, a metal shielding layer 52 and an outer insulative layer 51 from its inside to outside in turn. In addition, the conductive wire 5 can be composed in another composition, it comprises a pair of conductors 54′, two inner insulative layers 53′ respectively surrounding the conductors 54′, a metal shielding layer 52′ surrounding the two inner insulative layer 53′ and an outer insulative layer 51′ surrounding the metal shielding layer 52′. Two inner insulative layers 53′ of the cable 5 can be easily guided to the first channels 414 by the chamfers 4142 formed on the slot walls 4141.

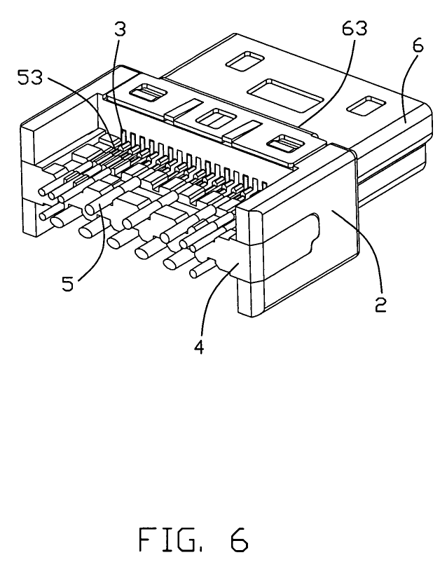

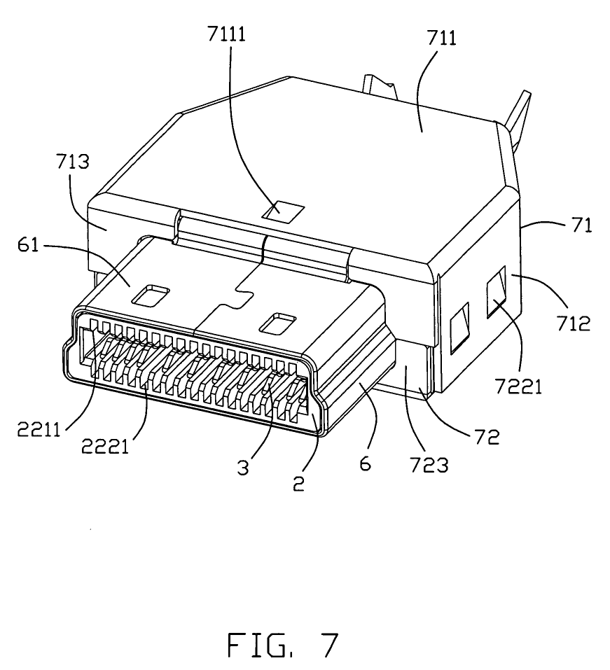

Referring to FIGS. 2 to 3 and 6 to 7, the first metal shell 6 can be stamped and bent from a metal sheet, it comprises a surrounding portion 61, a pair of upper and lower latch portions 64, 65 and a pair of upper and lower connecting portions 62, 63 connecting with the surrounding portion 61 and the upper and lower latch portions 64, 65. The surrounding portion 61 includes a top wall 611, a bottom wall 612 and a pair of first side and second side walls 613, 614 connecting with the top wall 611 and the bottom wall 612. The top wall 611 defines two holes 6111 and the bottom wall 612 defines three holes 6121 respectively arranged along widthwise direction. The first side wall 613 defines two posts 6131, 6132 extending rearwardly from the rear end thereof, and the second side wall 614 also defines two posts 6141, 6142 thereof. The upper and lower connecting portions 62, 63 extend upwardly and downwardly from the rear end of the top wall 611 and the bottom wall 612 respectively. The upper latch portion 64 extending horizontally and backwardly from the rear end of the upper connecting portion 62 defines two holes 641, two elastic tabs 642 and an opening 643 thereof, and the lower latch portion 65 extending horizontally and backwardly from the rear end of the lower connecting portion 63 defines three holes 651 and two elastic tabs 652 thereof. The surrounding portion 61 of the first metal shell 6 is fitted around the mating portion 22 and engaged with the body portion 21 of the insulative housing 2.

The second metal shell 7 can also be stamped and bent from a metal sheet, it comprises an upper shell 71 and a lower shell 72 engaged to the upper shell 71.

The upper shell 71 includes a top wall 711, a pair of side walls 712 extending downwardly from two opposite sides of the top wall 711, a pair of front wall 713 extended downwardly from two sides of the front end of the top wall 711 and a pair of rear wall 714 extended inwardly from rear end of the side walls 712. The top wall 711 defines a tab 7111 extended downwardly and the side walls 712 each has two holes 7121 thereof.

The lower shell 72 includes a bottom wall 721, a pair of side walls 722 extended upwardly from two opposite sides of the bottom wall 721, a pair of front walls 723 extended upwardly from two sides of the front end of the bottom wall 721 and a pair of rear walls 724 extended inwardly from rear end of the side walls 722. The bottom wall 721 defines a tab 7211 extended upwardly and the side walls 712 each defines two projection 7221 for engaging with the holes 7121 of the upper shell 71.

Referring to FIGS. 1 to 3 and 8, the insulative cover 8 includes an upper cover 81 and a lower cover 82 which are formed in advance. The upper cover 81 and lower cover 82 are respectively assembled to the upper and lower shell 71, 72 of the second metal shell 7, then the upper cover 81 and the lower cover 82 are integrated by ultrasonic welding process.

Referring to FIGS. 1 to 8, the assembling process of the cable assembly 1 in according to the present invention starts from assembling the terminals 3 which are arranged two opposite rows to the insulative housing 2 in a rear to front direction. The terminals 3 are passed through the upper and lower slots 231, 232 of the supporting member 23, the upper and lower passageways 215, 216 of the body portion 21 and the upper and lower channels 2211, 2221 of the mating portion 22 in turn which are communicated with each other. When the terminals 3 are whole assembled to insulative housing 2, the serrated protrusion 312 of the fixing portion 31 are interfered with the upper and lower passageways 215, 216 of the insulative housing 2 making the terminals 3 fixed in the insulative housing 2. The connecting portion 32 are received into the upper and lower slots 231, 232 of the supporting member 23. The contact pieces 33 are disposed in the upper and lower channels 2211, 2221 of the mating portion 22 and the contact portion 332 of the contact pieces 33 are located at the upside of the upper and lower channels 2211, 2221.

After the terminals 3 are assembled to the insulative housing 2, then assembling the insulative organizer 4 to the rear end of the insulative housing 2 in a rear to front direction. A pair of the U-shaped projections 422, 432 of the insulative organizer 4 are respectively received into the U-shaped slot 241, 251 of the insulative housing 2 and engaged with each other by the slender ribs 4221, 4321 of the U-shaped projections 422, 432. The front end of the basic plates 421, 431 are received in the spaces formed between the first and second side wall 24, 25 and the supporting member 23. The front surface of the base portion 41 of the insulative organizer 4 is attached to rear surface of the supporting member 23 of the insulative housing 2. The first channels 414 of the base portion 41 are corresponding to a few of upper and lower slots 231, 232 of the supporting member 23 and communicated with each other.

After the insulative organizer 4 is assembled to the insulative housing 2, then assembling a plurality of conductive wires 5 to the insulative organizer 4. The inner insulative layers 53, 53′ of the conductive wires 5 are received in the first channels 414 and positioned in the insulative organizer 4 by the interference between the inner insulative layers 53, 53′ and the slot wall 414. The outer insulative layers 51, 51′ of the conductive wires 5 are also received and positioned in the second channels 415. The conductors 54, 54′ exposed outside of the inner insulative layers 53, 53′ are received into the upper and lower slots 231, 232 of the supporting member 23 and located at the upside of the connecting portions 32 of the terminals 3. Then welding the conductors 54, 54′ and the connecting portions 32 of the terminals 3 in the connecting area through hot bar method.

After the conductive wires 5 are assembled to the insulative organizer 4 and welded with the terminals 3, then assembling the first metal shell 6 to the insulative housing 2. Accordingly, the surrounding portion 61 of the first metal shell 6 is fitted around the mating portion 22 of the insulative housing 2, the two posts 6131, 6132 of the first side wall 613 and the two posts 6141, 6142 of the second side wall 614 are all received into the holes 2111, 2112 of the body portion 21. The upper and lower connecting portions 62, 63 are attached to the front surface 211 of the body portion 21. The upper and lower latch portions 64, 65 are engaged with the body portion 21 of the insulative housing 2 by the engagement between the holes 641, 651 and the projection 2131, 2141.

Then, assembling the upper shell 71 and lower shell 72 of the second metal shell 7 to the rear end of the insulative housing 2. The tab 7111 of the upper shell 71 is received into the recess portion 2132, and the tab 7211 of the lower shell 72 is received into the recess portion 2142. The upper and lower shells 71, 72 are engaged by the engagement between the holes 7121 of the side walls 712 and the projections 7221 of the side walls 722.

At last, assembling the upper insulative cover 81 and lower insulative cover 82 to the upper shell 71 and lower shell 72 respectively, then the upper cover 81 and the lower cover 82 are integrated by ultrasonic welding process.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What we claimed is:

1. A cable assembly, comprising:
an insulative housing defining a body portion and a supporting member extending rearwardly from the body portion, and the supporting member having a plurality of upper and lower slots thereof;
a plurality of terminals received in the insulative housing and having a portion disposed in the upper and lower slots respectively;
an insulative organizer assembled to the rear end of insulative housing and attached to the supporting member, having a plurality of first and second channels spaced by each other and respectively formed on the front and rear portion thereof; and
a plurality of conductive wires positioned in the first and second channels of the insulative organizer and electrically terminated to the corresponding terminals disposed in the upper and lower slots.

2. The cable assembly as recited in claim 1, wherein at least one conductive wire comprises an outer insulative layer, a metal shielding layer, an inner insulative layer and a conductor arranged from outside to inside thereof, and the inner insulative layer received and positioned in the first channels, the outer insulative layer received and positioned in the second channels.

3. The cable assembly as recited in claim 1, wherein the width of the first channel is narrower than the second channel, a plurality of first channels are corresponding to the second channels in a one-to-one relationship, and a plurality of first channels are corresponding to the second channels in a two-to-one relationship.

4. The cable assembly as recited in claim 1, wherein at least one conductive wire comprises an outer insulative layer, an metal shielding layer surrounded by the outer insulative layer and a pair of inner insulative layers surrounded by metal shielding layer, and each inner insulative layer has a conductor therein.

5. The cable assembly as recited in claim 4, wherein the pair of inner insulative layers are received and positioned in the adjacent first channels and an outer insulative layer is received and positioned in the second channels.

6. The cable assembly as recited in claim 1, wherein the insulative organizer comprises a base portion and a pair of first and second side portions each defining a pair of slender ribs formed on the two opposite surfaces thereof.

7. The cable assembly as recited in claim 6, wherein the insulative housing further comprises a mating portion extending forwardly from the body portion and a pair of first and second side walls extending rearwardly from two sides of the body portion.

8. The cable assembly as recited in claim 7, wherein the first and second side walls each has a slot for receiving the first and second side portions of the insulative organizer, and the insulative housing and the insulative organizer are interfered and engaged with each other by slender ribs form on the first and second side portions.

9. The cable assembly as recited in claim 2, wherein the terminals each comprises a fixing portion, a contact piece extending forwardly from the fixing portion and a connecting portion extending rearwardly from the fixing portion.

10. The cable assembly as recited in claim 9, wherein the contact pieces includes a resilient connecting arm extending forwardly from the fixing portion and a contact portion extending upwardly and provided at distal ends of the contact pieces.

11. The cable assembly as recited in claim 9, wherein the fixing portion has at least one hole at a substantially center portion thereof.

12. The cable assembly as recited in claim 9, wherein the connecting portion of the terminals are disposed in the upper and lower slots and electrically terminated to the conductors of the conductive wires.

13. The cable assembly as recited in claim 1, wherein the cable assembly further comprises a first metal shell and a second metal shell assembled to the insulative housing.

14. The cable assembly as recited in claim 1, wherein the cable assembly further comprises an insulative cover including an upper cover and a lower cover assembled to the second metal shell.

15. The cable assembly as recited in claim 13, wherein the upper cover and the lower cover are integrated by ultrasonic welding process.

16. An electrical connector assembly comprising:
an insulative housing defining a row of passageways each extending along a front-to-back direction;
a set of contacts received in the corresponding passageways, respectively, each of said contacts defining a solder tail;
an insulative organizer position located behind the housing and defining first, second and third platforms at different upper, middle and lower levels;
a plurality to first channels formed in the first platform;
a plurality of second channels formed in the third platform; and
a set of cables each including an inner conductor, an inner insulator, and outer conductor and an outer insulator in sequence, said inner conductors being soldered to the solder tails of the corresponding contacts, some of said cables having the outer conductors and the outer insulators joined together; wherein
an amount of said first channels is more than that of the second channels under a condition that the inner insulators are respectively received in the corresponding first channels, and the outer insulator are respectively received in the corresponding second channels.

17. The electrical connector assembly as claimed in claim 16, further including another row of passageways, another set of contacts, another set of cables, and third and fourth channels in the wire organizer respectively receiving inner insulators and outer insulators of said another set of cables, wherein an amount of said third channels is not same with that of said first channels, and respective positions of said third channels are not aligned with those of the first channels in a vertical direction perpendicular to a front-to-back direction.

18. The electrical connector assembly as claimed in claim 17, wherein an amount of said fourth channels is not same with that of the second channels, and respective positions of said fourth channels are not aligned with those of the second channels in the vertical direction.

19. An electrical connector comprising:
an insulative housing defining a row of passageways each extending along a front-to-back direction;
a set of contacts received in the corresponding passageways, respectively, each of said contacts defining a solder tail;
an insulative organizer position located behind the housing and defining first and second channels therein at two different levels;
a supporting member unitarily extending from a rear face of the housing defining a plurality of slots therein in alignment with the corresponding passageways, respectively;
the first channels receiving the corresponding inner conductors, respectively;
the slots received the corresponding solder tails, respectively;
an amount of the first channels is equal to that of the slot while being different from that of the second channels, and positions of said first channels are aligned with those of the slot in a front-to-back direction while being offset from those of the second channels.

20. The electrical connector assembly as claimed in claim 19, wherein each of said slots defines a larger depth in a front portion thereof and a smaller depth in a rear portion thereof so as to protectively receive both the corresponding inner conductor and the solder tail of the corresponding contact in the front portion for easily positioning the inner conductor upon the solder tail of the corresponding contact, while only receiving the solder tail of the corresponding contact in the rear portion with exposing the corresponding inner conductor to an exterior for easy soldering.
